(19) United States
(12) Patent Application Publication
(10) Pub. No.: US 2013/0321212 A1
(43) Pub. Date: Dec. 5, 2013

(54) VOLUMETRICALLY CONFIGURABLE MONOPOLE ANTENNAS AND RELATED METHODS

(71) Applicants: Dermot O'Shea, San Diego, CA (US); Ronan Quinlan, Zhongli City (TW)

(72) Inventors: Dermot O'Shea, San Diego, CA (US); Ronan Quinlan, Zhongli City (TW)

(73) Assignee: TAOGLAS GROUP HOLDINGS LIMITED, Wexford (IE)

(21) Appl. No.: 13/488,306

(22) Filed: Jun. 4, 2012

(51) Int. Cl. H01Q 9/14

(52) U.S. Cl. 343/700 MS

(57) ABSTRACT

A dual resonance monopole antenna is described wherein the antenna structure, ground connection conductor and transmission line are integrated onto a single substrate. The substrate can be of a thin, flexible type that provides for positioning one or both resonant sections of the dual resonant monopole in the plane of or orthogonal to the ground plane of the host device to provide flexibility in selecting impedance and radiation characteristics. The ground connection conductor is configured to work in conjunction with features etched into the ground layer of the host device to form a method of altering the impedance properties of one or multiple resonances of the monopole.

### BACKGROUND OF THE INVENTION

1. Field of the Invention

This invention relates to antennas and methods for use in wireless communications. More particularly, the invention relates to antennas having one or more monopole type elements adapted for multiple resonance signaling and being configured on a flexible substrate for volumetric configuration of the antenna within a wireless communication system, and related methods for fabrication and tuning thereof.

2. Description of the Related Art

As trends in wireless communication technology continue to rapidly develop, the design trend in current portable electronic devices such as laptop computers, mobile phones, and personal digital assistants (PDAs) continues to move toward lighter and thinner device attributes. As such, antennas for use in these portable electronic devices are collaterally affected by these trends and presently require reductions in antenna volume and other physical attributes while maintaining or enhancing performance characteristics in an effort to meet manufacturer and consumer expectations.

Moreover, additional frequency bands are being required for portable communication devices, making the antenna design effort increasingly difficult. To cover these additional frequency bands, multiple resonances are required from the antenna, and positioned in frequency to provide efficient transmission and reception. This requirement for multiple resonances excludes certain antenna types from being implemented.

Conventional monopole type antennas provide a single resonance that can be tuned to cover a single frequency band. A primary benefit of a monopole antenna is the ability to work well in close proximity to a ground plane, making this type antenna conducive to use in commercial communication devices for portable applications. Additional resonances are generated from a monopole, which are harmonics of the dominant resonance. These harmonics occur at integer multiples of the fundamental resonance, however with little ability to shift the frequency response to effectively transmit or receive at additional frequency bands. This limitation in the ability to generate and control additional resonances from monopole antennas in a small size continues to present a longstanding problem in the art.

Monopole antennas can be fabricated using many types of manufacturing technology. The monopole can be printed on a printed circuit board (PCB) in the form of a copper foil displayed in a two dimensional shape, or can be provided as a three dimensional design from metal sheet forming processes. The two dimensional shape lends itself to photo-etching techniques on PCBs and aids in integration into portable electronic devices due to reduced volume of the two dimensional design.

Monopole antennas require a feed signal to operate, the feed signal typically provided by a transmission line, and the distance from the monopole to the ground plane is critical for the tuning the monopole antenna. Connecting the center conductor of a transmission line to the monopole and the ground connector of the transmission line to the ground plane can be difficult for monopole antennas used within a portable device, which is why many devices continue to comprise external-type monopole antennas which extend outward from the device housing. In practice, volumetric placement of the monopole is restricted within a device due to the requirement of grounding the conductor of the transmission line to the ground plane of the PCB of the portable device. A separate coaxial connector can often be required at the feed point of the monopole to provide reliable and consistent connection of the transmission to the ground plane of the PCB.

With the ongoing need for small, lightweight, and low cost antennas in wireless devices, and with the additional requirement of covering several frequency bands, a method of integrating and connecting to a multiple resonance antenna is required. In order to utilize monopole type antennas in view of the continuing trends, a method for implementing a second resonance of a monopole antenna is needed to provide the additional resonance for additional frequency coverage as required by modem trends.

### SUMMARY OF EMBODIMENTS OF THE INVENTION

In view of the above limitations in the art, a monopole type antenna is provided for use in wireless communications systems, the monopole type antenna comprises two resonant sections for accommodating multiple application requirements of modem wireless communications systems. The dual resonances of the two resonant sections may comprise a high frequency resonance and a low frequency resonance. Moreover, the dual resonance monopole is disposed on a flexible substrate for providing a bendable volumetric configuration of the antenna for altering various characteristics such as impedance and frequency response and providing dimensional tuning of the antenna within a confined space of a portable communications device.

In one embodiment, one or more conductors of the antenna architecture are volumetrically positioned to enhance harmonics of the monopole type radiator for providing additional resonances for use in applications of modern devices.

In another embodiment, two or more conductors of the antenna architecture are volumetrically positioned in orthogonal relation for providing two or more resonances for use in applications of modem devices.

In yet another embodiment, a method is provided for fabricating and tuning a monopole type antenna for use with modem communications systems.

Other features and advantages will become apparent to those having skill in the art upon further review of the appended detailed description of the various embodiments.

### BRIEF DESCRIPTION OF THE DRAWINGS

FIG. 1A illustrates a front view of a dual resonance monopole antenna in accordance with embodiments of the invention, the antenna is fabricated on a substrate with a coaxial transmission line attached for feeding the antenna.

FIG. 1B illustrates a rear view of the antenna of FIG. 1A, the rear side of the substrate comprises a grounding strap with plated thru vias extending to connect ground straps on opposing sides of the substrate.

FIG. 2 illustrates three portions of the antenna radiating structure including: a feed conductor, the high frequency conductor, and the low frequency conductor.

FIG. 3 illustrates a dual resonance monopole on a single substrate attached to the circuit board of the host device.

FIG. 4 illustrates a dual resonance monopole on a single substrate attached to the circuit board of a host device. The dual resonance monopole is curved such that the high frequency conductor is predominantly disposed within a common plane of the ground plane of the host device, whereas the low frequency conductor is in a plane that is predominantly orthogonal to the ground plane of the host device.

FIG. 5 illustrates a dual resonance monopole on a single substrate attached to the circuit board of the host device. The dual resonance monopole is curved such that the high frequency conductor is predominantly in a plane that is orthogonal to the ground plane of the host device, whereas the low frequency conductor is predominantly in a plane that is parallel with the ground plane of the host device.

FIG. 6 illustrates a dual resonance monopole attached to the ground plane of the host device, with a portion of the ground plane removed to alter the impedance of the monopole.

FIGS. 7(A-B) illustrates a dual resonance monopole with a ground conductor that has been altered to modify the radiation pattern of both the low frequency and high frequency resonance.

FIG. 8 illustrates a dual resonance monopole with a ground conductor adjusted to change the radiation patterns of both the low frequency and high frequency resonances.

FIGS. 9(A-E) illustrates multiple configurations of the dual resonance monopole radiating structure and ground strap portions disposed on a single substrate.

### DETAILED DESCRIPTION OF THE PREFERRED EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

In a general embodiment, a volumetrically configurable dual resonance monopole antenna comprises a substrate, a radiating structure disposed on the substrate, and a grounding strap. The substrate is formed from a thin-sheet of dielectric material. The sheet of material is adapted for flexible configuration, or bending, and has a first planar surface and a second planar surface opposite of the first planar surface. The radiating structure disposed on the substrate comprises a monopole-type radiator having a first resonant section adapted to radiate at a first frequency (f₁) and a second resonant section adapted to resonate at a second frequency (f₂). The first and second resonant sections are connected at a common feed. The grounding strap comprises at least a first grounding portion disposed on the first planar surface of the substrate and a second grounding portion disposed on the second planar surface of the substrate opposite of the first planar surface. The first and second portions of the grounding strap are connected by a plurality of thru vias extending through the substrate from the first planar surface to the second planar surface. In this regard, the radiating structure is adapted for volumetric configuration by bending the flexible substrate and radiating structure thereon to yield desired impedance and radiation characteristics of the resulting structure.

In one embodiment, a single integrated assembly comprises a dual resonance monopole antenna with integrated coaxial transmission line and ground connection. With the antenna and ground connection fabricated on a single substrate, antenna attachment to a PCB of a wireless or portable device is enhanced.

In another embodiment, a feed conductor is used to feed two antenna radiator sections. Each of the antenna radiator sections can be individually adjusted by configuring size, shape, and position about a substrate in order to radiate at a desired frequency. The two antenna radiator sections may comprise a low frequency conductor and a high frequency conductor, wherein the low frequency conductor is relatively larger than a high frequency conductor. The low frequency conductor can be adjusted to resonate at a first frequency (f₁), while the high frequency conductor can be adjusted to resonate at a second frequency (f₂) such that f₂ is distinct from f₁. The first frequency (f₁) is generally lower than the second frequency (f₂), due to the relatively larger size of the low frequency conductor relative to the high frequency conductor. All three of the antenna conductors can be fabricated on a single substrate, and this substrate can be flexible to allow for forming into a three-dimensional shape. The feed conductor, low frequency conductor, and high frequency conductor yield a three-conductor embodiment.

In this regard, the feed conductor being connected to the low and high frequency conductors provides a dual resonance monopole, wherein the antenna comprises a first resonance at the low frequency conductor and a second resonance at the high frequency conductor, each being commonly connected at a junction with the feed conductor.

In another embodiment of the present invention, a transmission line, such as a coaxial transmission line, can be connected to the dual resonant monopole. The center conductor, or “feed connector” of the transmission line is connected to the feed conductor of the dual resonant monopole. The “ground connector”, or the outer conductor in the case of a coaxial transmission line, can be connected to the reference ground of the circuit, printed circuit board (PCB), or other ground plane available for connection.

In another embodiment, a fourth conductor is added to the three conductor embodiment described above, with the fourth conductor used as a ground connection or “ground strap”. This fourth conductor can be connected to the ground connnector of the transmission line, with the ground connector being further connected to a reference ground of the host device. The fourth conductor, or ground strap, can be fabricated on the same single substrate as the other three conductors (radiators). The ground strap can be fabricated on opposing sides of the substrate, with the portions of the ground strap connected to each other by way of plated thru vias extending through the substrate.

In another embodiment, the substrate can be bent into a curved surface such that the high frequency conductor of the dual resonant monopole can be positioned in a plane that is predominately orthogonal to the ground plane of the portable device, whereas the low frequency conductor of the dual resonant monopole can be positioned in a plane that is predominately co-planar to the ground plane of the portable device. The orientation of each conductor of the dual resonance monopole can be used to alter the resonant frequency, impedance, radiation patterns, and radiation efficiency of the monopole.

In another embodiment, the substrate can be flexible and bent into a curved surface such that the high frequency conductor of the dual resonant monopole can be positioned in a plane that is predominately co-planar to the ground plane of the portable device, whereas the low frequency conductor of the dual resonant monopole can be positioned in a plane that is predominately orthogonal to the ground plane of the portable device. The orientation of each conductor of the dual resonant monopole can be used to alter the resonant frequency, impedance, radiation patterns, and radiation efficiency of the monopole.

In certain embodiments, at least one of the first and second resonant sections of the radiating structure is disposed in a common plane with the host device ground plane.

In another embodiment, the length of and separation distance, or “gap”, between the ground conductor and the high frequency and low frequency conductors of the dual monopole can be adjusted to change the radiation pattern of the first frequency (f₁) and/or the second frequency (f₂) when the dual monopole antenna is not connected to the ground plane of the portable device.

A detailed description of the invention will now be made with reference to the accompanying drawings, wherein:

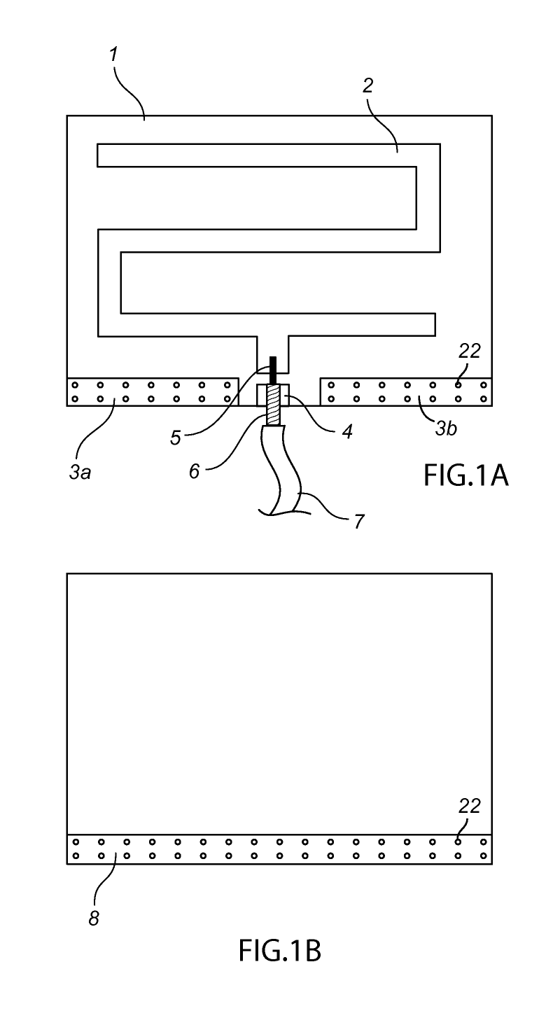

FIG. 1 illustrates a dual resonance monopole 2 fabricated on a substrate 1 with a coaxial transmission line 7 attached for feeding the antenna. A two-section grounding strap 3a; 3b is fabricated on the front side of the substrate. The back side of the substrate contains a grounding strap 8. The two sections of the grounding strap 3a; 3b on the front side of the substrate are connected to the grounding strap 8 by plated thru vias 22 extending through the substrate. The center conductor 5, or “feed connector”, of the coaxial transmission line 7 makes contact with the dual resonance monopole radiating structure 2. The outer conductor 6 of the coaxial transmission line 7 makes contact with a conductive pad 4. The conductive pad 4 is further attached to grounding strap 8 using plated thru vias.

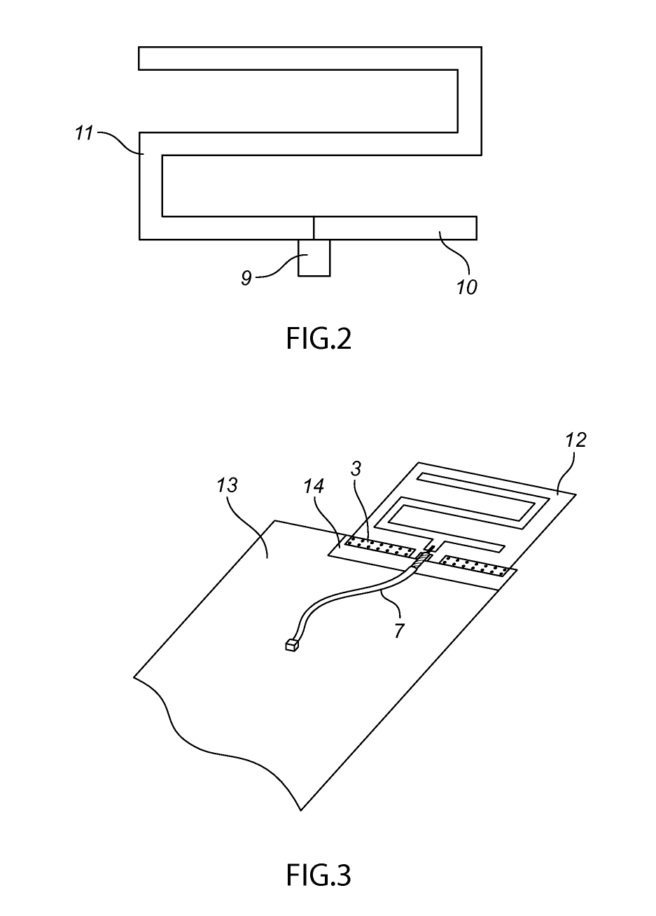

FIG. 2 illustrates a dual resonance monopole, with the monopole displayed in three sections for explanation of their respective roles. Conductive section 9 is a feed conductor. Conductive section 10 is a high frequency monopole conductor. Conductive section 11 is a low frequency monopole conductor. In this regard, a common feed is used to drive each of the high frequency and low frequency conductors of the dual resonance monopole.

FIG. 3 illustrates a dual resonance monopole assembly 12 comprising a dual resonance monopole fabricated on a single substrate, the dual resonance monopole assembly is attached to the ground plane 14 of a host device 13. The grounding strap 3 on the dual resonance monopole assembly 12 is attached to the ground plane of the host device. The coaxial transmission line 7 is connected to a connector on the host device 13. In this regard, the dual resonance monopole assembly comprises a high frequency resonance and a low frequency resonance and is adapted for attachment with a host device using a coaxial cable as illustrated.

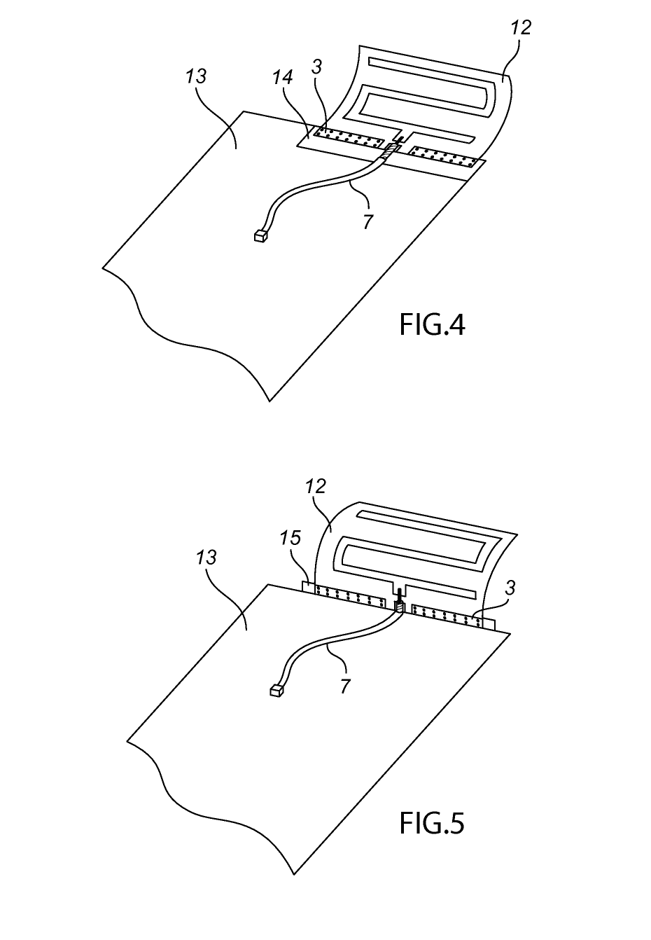

FIG. 4 illustrates a dual resonance monopole assembly 12 comprising a high frequency conductor and a low frequency conductor disposed on a single substrate, the assembly 12 is attached to the ground plane 14 of a host device 13. At least a portion of the grounding strap 3 of the dual resonance monopole assembly 12 is attached to the ground plane of the host device. The coaxial transmission line 7 is connected to a connector on the host device 13. The dual resonant monopole assembly 12 is bent or curved such that the high frequency conductor portion is predominantly disposed in a common plane with respect to the ground plane 14 of the host device 13; whereas the low frequency conductor portion is in a plane that is predominantly orthogonal to the ground plane 14 of the host device 13.

FIG. 5 illustrates a dual resonance monopole assembly 12 comprising a high frequency conductor and a low frequency conductor disposed on a single substrate, the assembly 12 is attached to the ground plane 14 of a host device 13. The grounding strap 3 on the dual resonance monopole 12 is attached to a ground section 15 connected to the ground plane of the host device 13. The coaxial transmission line 7 is connected to a connector on the host device 13. The dual resonant monopole assembly 12 is curved such that the high frequency conductor is predominantly in a plane that is orthogonal to the ground plane of the host device 13; whereas the low frequency conductor is predominantly in a plane that is parallel with the ground plane of the host device 13.

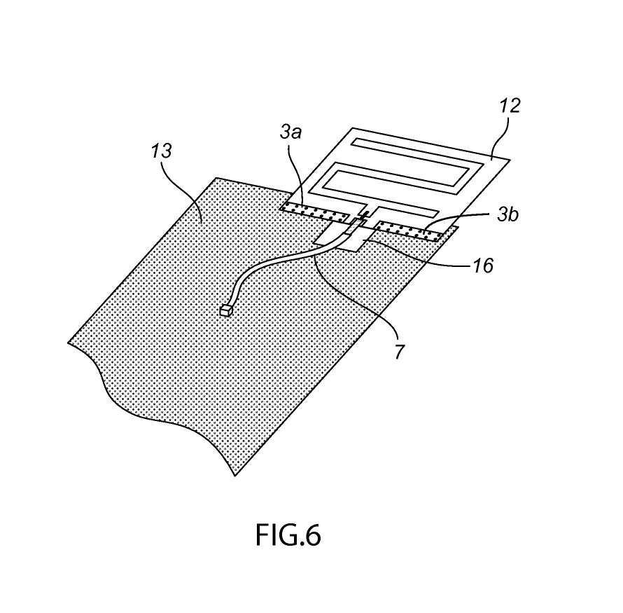

FIG. 6 illustrates a dual resonance monopole assembly 12 comprising a high frequency conductor and a low frequency conductor disposed on a single substrate, the assembly 12 is attached to the ground plane of a host device 13. A two section grounding strap 3a; 3b is attached to the ground plane of the host device 13. The coaxial transmission line 7 is connected to a connector on the host device 13. A portion of the ground plane 16 of the host device 13 is removed for altering the impedance of the dual resonance monopole assembly 12. In certain embodiments, a section of the host device ground plane is removed within the vicinity of the feed point of the monopole antenna. The area of ground plane removal is dimensioned to alter the impedance of the antenna.

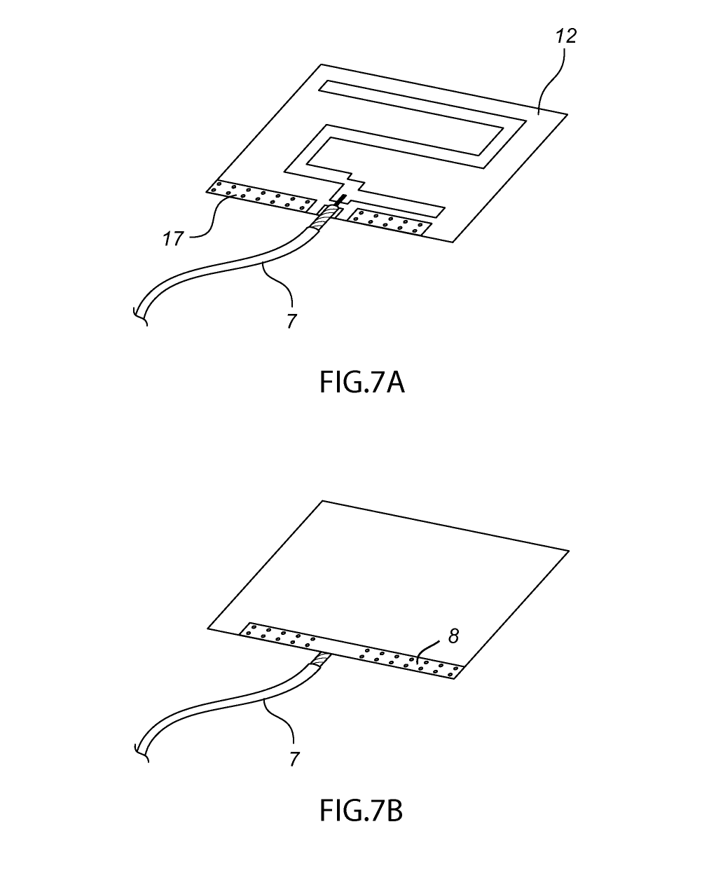

FIGS. 7(a-b) illustrate a dual resonance monopole assembly 12 comprising a high frequency conductor and a low frequency conductor disposed on a single substrate with a transmission line 7 connected to a common feed of the monopole radiator. The ground conductor 17 is configured with a desired length and separation distance from the radiating conductor for tuning the radiating characteristics of the antenna. Note that a first grounding strap portion is disposed further away from a low frequency radiating portion of the antenna; whereas a second grounding strap portion comprises a shorter length than the first grounding strap portion and is positioned closer in proximity to the high frequency radiating portion, respectively. In this regard, the low frequency and high frequency resonances are tuned to yield the desired characteristics of the antenna. Moreover, with the shortened length of the second grounding portion, the reverse side of the assembly is adapted with a shortened grounding strap 8 as illustrated in FIG. 7b.

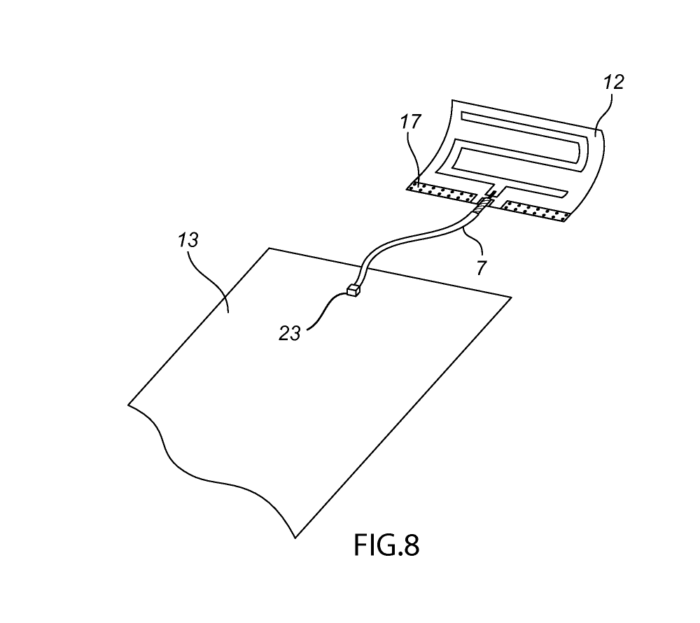

FIG. 8 illustrates a dual resonance monopole assembly 12 comprising a high frequency conductor and a low frequency conductor disposed on a single substrate with a ground conductor 17 adjusted to configure the radiation pattern of both the low and high frequency resonances. The dual resonance antenna on the flexible substrate is not connected to the ground plane of the PCB 13. The transmission line 7 is connected to a connector 23 located on the PCB 13. In this regard, the antenna assembly 12 is not required to be connected to the ground plane of the host device at a grounding strap. With the shortened effective ground plane, the frequency response of the antenna is altered.

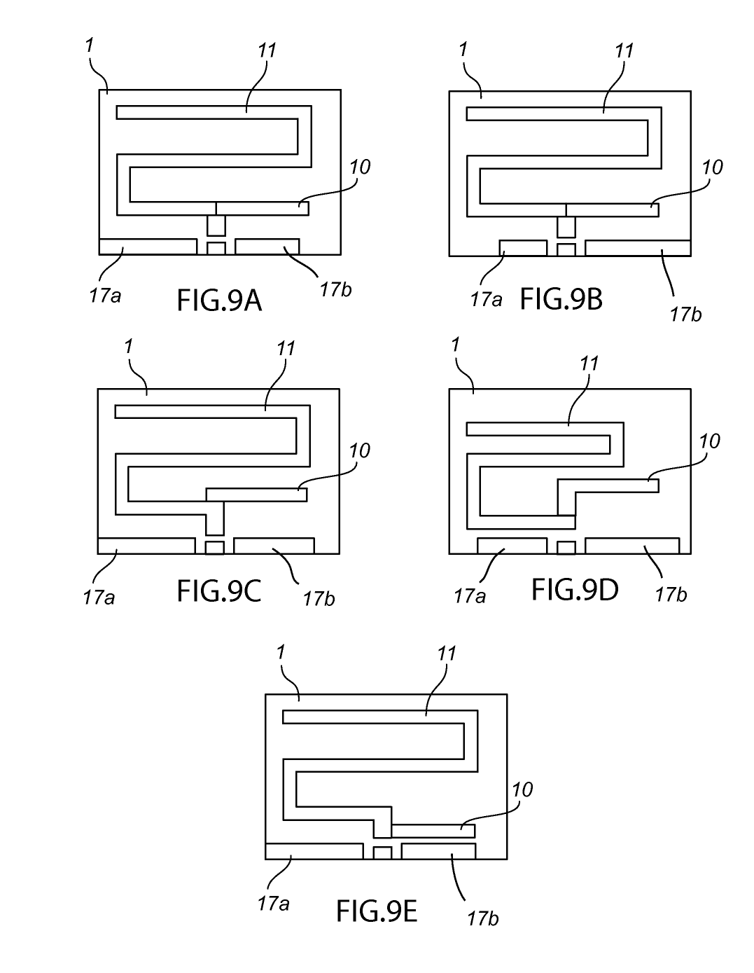

FIGS. 9(a-e) illustrate a number of respective examples of various conductor and ground conductor configurations. FIG. 9a shows a ground conductor 17b that is shorter than conductor 10. FIG. 9b shows a ground conductor 17b that is longer than conductor 10 but shorter than the portion of conductor 11 which is in proximity to conductor 17a. FIG. 9c shows conductor 10 with increased separation from ground conductor 17, the separation between the ground portion and the resonant section forms a “gap”. FIG. 9d shows conductor 10 with increased separation, or a larger gap, between ground conductor 17 and the portion of conductor 11 in proximity to the ground conductor with reduced separation the ground conductor 17. FIG. 9e shows conductor 10 with decreased separation from ground conductor 17 and the portion of conductor 11 in proximity to the ground conductor with increased separation the ground conductor 17. Various configurations and designs may yield a dual resonance monopole type antenna disposed on a flexible substrate, wherein one or more portions of a grounding strap are disposed adjacent to the monopole antenna. Thus, the invention is not intended to be limited to the illustrated embodiments.

In another aspect of the invention, a method for forming an antenna comprises: providing the volumetrically configurable monopole type antenna described above, connecting the antenna to a host device; and bending the substrate and radiating structure thereon to configure impedance and/or frequency characteristics of the antenna. The method may further include: removing a portion of a ground plane of the host device adjacent to a feed of the antenna radiator.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A volumetrically configurable dual resonance monopole antenna, comprising:
a substrate comprising a thin-sheet of dielectric material adapted for flexible configuration and having a first planar surface thereof and a second planar surface opposite of the first planar surface;
a radiating structure disposed on said substrate, the radiating structure comprising a monopole type radiator having a first resonant section adapted to radiate at a first frequency and a second resonant section adapted to resonate at a second frequency, the first and second resonant sections being connected at a common feed;
a grounding strap comprising at least a first grounding portion disposed on the first planar surface of the substrate and a second grounding portion disposed on the second planar surface of the substrate opposite of the first planar surface, the first and second portions of the grounding strap being connected by a plurality of thru vias extending through the substrate from the first planar surface to the second planar surface; and
wherein said radiating structure is adapted for volumetric configuration by bending the flexible substrate and radiating structure thereon.

2. The antenna of claim 1, further comprising a transmission line, the transmission line comprising a feed connector and a ground connector, the feed connector being coupled to the common feed of the radiating structure, and the ground connector being coupled to one of said grounding portions, the transmission line being further adapted to couple with a circuit of a host device.

3. The antenna of claim 1, comprising a first grounding portion and a second grounding portion each being disposed on the first planar surface of the substrate, and a third grounding portion disposed on the second side of the substrate opposite of the first side.

4. The antenna of claim 3, wherein said first grounding portion is disposed adjacent to the first resonant section of the radiating structure.

5. The antenna of claim 4, wherein said second grounding portion is disposed adjacent to the second resonant section of the radiating structure.

6. The antenna of claim 5, wherein at least one of said first and second grounding portions is shorter than an adjacent portion of the radiating structure.

7. The antenna of claim 5, wherein at least one of said first and second grounding portions is longer than an adjacent portion of the radiating structure.

8. The antenna of claim 3, further comprising a fourth grounding portion being disposed on the first side of the substrate adjacent to the common feed of the radiating structure, the fourth grounding portion being further disposed between the first and second grounding portions and connected to the third grounding portion by way of one or more thru vias extending from through the substrate from the first surface to the second surface.

9. The antenna of claim 5, wherein a first gap formed between the first resonant section and the first grounding strap is larger than a second gap formed between the second resonant section and the second grounding strap.

10. The antenna of claim 5, wherein a first gap formed between the first resonant section and the first grounding strap is smaller than a second gap formed between the second resonant section and the second grounding strap.

11. The antenna of claim 2, said host device comprising a printed circuit board forming a host device ground plane.

12. The antenna of claim 11, wherein said substrate is volumetrically configured with said first resonant section of the radiating structure being positioned in a plane that is substantially parallel with the host device ground plane and the second resonant section of the antenna radiator being positioned in a plane that is substantially orthogonal to the host device ground plane.

13. The antenna of claim 11, wherein said substrate is volumetrically configured with said second resonant section of the radiating structure being positioned in a plane that is substantially parallel with the host device ground plane and the first resonant section of the antenna radiator being positioned in a plane that is substantially orthogonal to the host device ground plane.

14. The antenna of claim 11, wherein at least one of said first and second resonant sections of the radiating structure is disposed in a common plane with the host device ground plane.

15. The antenna of claim 11, wherein said antenna is connected to the host device ground plane at a grounding portion thereof.

16. The antenna of claim 15, wherein a portion of the host device ground plane is removed to alter the impedance of the antenna.

17. The antenna of claim 1 volumetrically configured or bent to form a curved geometry thereof.

18. A volumetrically configurable dual resonance monopole antenna, comprising:
a substrate having a first planar surface and a second planar surface opposite of the first planar surface;
a radiating structure disposed on the substrate, the radiating structure comprising a first resonant section adapted to resonate at a high frequency and a second resonant section adapted to resonate at a low frequency; and
a grounding strap comprising a first portion thereof disposed on the first planar surface of the substrate and a second portion thereof disposed on a second planar surface of the substrate, the first and second portions of the grounding strap being connected by one or more thru vias extending through the substrate from the first surface to the second surface, the grounding strap being dimensioned, shaped, and positioned to tune the frequency response of the radiating structure at the high frequency and low frequency resonances;
wherein said substrate is adapted for volumetric configuration for adjusting one or more of impedance and frequency characteristics of the antenna.

19. A method for forming an antenna, comprising:
providing the volumetrically configurable monopole type antenna of claim 18,
connecting the antenna to a host device; and
bending the substrate and radiating structure thereon to configure one or more of impedance and frequency characteristics of the antenna.

20. The method of claim 19, further comprising: removing a portion of a ground plane of the host device adjacent to a feed of the antenna radiator.
